(19) United States
(12) Patent Application Publication
(10) Pub. No.: US 2015/0281998 A1
(43) Pub. Date: Oct. 1, 2015

(54) NETWORK ACCESS SELECTION BASED ON INTERNET PROTOCOL-MEDIA SUBSYSTEM SERVICE

(71) Applicants: Frederic Joly, Aspremont (FR); Vivek G. Gupta, San Jose, CA (US); Alexandre Saso Stojanovski, Paris (FR)

(72) Inventors: Frederic Joly, Aspremont (FR); Vivek G. Gupta, San Jose, CA (US); Alexandre Saso Stojanovski, Paris (FR)

(21) Appl. No.: 14/225,829

(22) Filed: Mar. 26, 2014

(51) Int. Cl. H04W 28/02

(52) U.S. Cl. CPC H04W 28/0268; H04W 28/08

(57) ABSTRACT

Embodiments of user equipment and a method for network access selection based on IMS service are generally described herein. In some embodiments, the method includes a UE receiving a message from an ANDSF server comprising an ANDSF MO that includes an inter-system routing policy (ISRP) based on an Internet Protocol (IP) Multimedia Subsystem (IMS) service identifier. The UE may then offload IMS traffic from the cellular network to a non-cellular network based on the IMS service identifier and the ISRP.

### TECHNICAL FIELD

Embodiments pertain to wireless communications. Some embodiments relate to wireless networks, such as 3GPP cellular networks and wireless fidelity (Wi-Fi) networks. Some embodiments relate to network access selection

### BACKGROUND

The 3GPP standard allows offloading of data traffic to other networks. This may provide a benefit in that high bandwidth applications can be offloaded to other networks to free up bandwidth on the cellular network. However, there are problems associated with the conventional offloading of traffic.

Thus, there are general needs for more efficient ways to offload traffic from a cellular network to a non-cellular network.

### BRIEF DESCRIPTION OF THE DRAWINGS

FIG. 1 illustrates an embodiment of a wireless network in accordance with some embodiments.

FIG. 2 illustrates a graphical representation of an embodiment of an ANDSF management object (MO) tree.

FIG. 3 illustrates a flowchart of an embodiment of a method for network access selection based on IMS services.

FIG. 4 is a functional block diagram of an embodiment of user equipment in accordance with the embodiment of FIG. 1.

FIG. 5 is a functional block diagram of a base station in accordance with the embodiment of FIG. 1.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

As defined by the 3^{rd} Generation Partnership Project (3GPP) standard, network selection rules enable the offloading of Internet Protocol (IP)-based traffic from 3GPP cellular networks to non-3GPP networks (e.g., Wi-Fi). These rules are provided by the access network discovery and selection function (ANDSF) and are typically referred to in the art as Inter-System Routing Policies (ISRP) or Inter-System Mobility Policies (ISMP).

The application of these rules to the traffic enables the IP connections on non-3GPP systems to be directly established or to bring the traffic back to the 3GPP cellular network. The discrimination of the traffic to offload may be based on one or more of: traffic flow filters based on source and/or destination addresses or ports; protocol type, domain name (FQDN); quality of service (QoS); an application unique identification (ID); and/or the service (Access Point Name (APN)). As applied to IP Multimedia Subsystem (IMS) services, this granularity can present a problem. It enables the offloading of all of the IMS services together or it enables the offloading of IMS services using a dedicated bearer or a dedicated QoS.

When a user with user equipment (UE) (e.g., terminal, mobile telephone) is communicating over a cellular network (e.g., 3GPP, LTE), it may be advantageous to the network operator and/or the UE to offload selected traffic (e.g., video, voice over IP (VoIP), IMS services, texting) to a non-cellular network (e.g., Wi-Fi). For example, a particular base station with which the UE is communicating may have limited bandwidth at a particular time or the particular traffic may operate more efficiently with greater bandwidth than the present network connection can provide.

Presently, cellular UE may offload traffic based on traffic flow filters, QoS, application unique ID and/or the service (APN). As applied to IMS services, this granularity may not be an efficient way to offload traffic. Since not all traffic consumes the same bandwidth, there may be situations where only certain high bandwidth applications may be offloaded.

The method for network access selection based on IMS service may enable the UE to dynamically offload selected IMS services based on an IMS service type. For example, with the more than twenty current IMS services, a network operator may define their own policies/rules for dynamically offloading, from the cellular environment to the Wi-Fi environment, only certain ones of currently executing IMS services. The new policies may be used to amend a current ANDSF Management Object tree that may be retrieved by the UE from the cellular network within which it is operating.

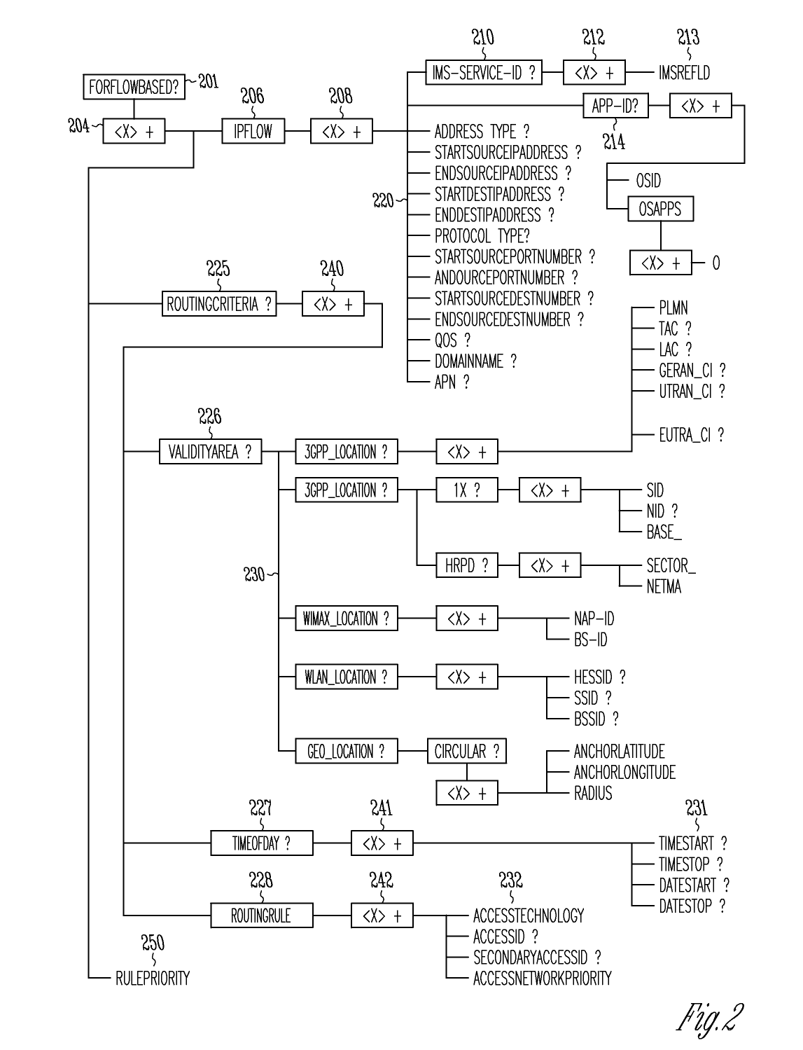

By increasing the granularity of offloading traffic, a network operator may have more flexible offload policies. For example, Rich Communication Service (RCS) video, higher-bandwidth, lower QoS, or RCS VoIP services may be offloaded to Wi-Fi while services using lower-bandwidth, higher QoS (e.g., VoLTE, Conversational Video Conferencing defined in IR94) may remain on the cellular network. Also, low bandwidth or security sensitive traffic applications such as chat, position sharing, or social presence information may also remain on the cellular network. On the other hand, bandwidth consuming IMS services that do not need a good QoS (e.g., file exchange, video sharing) may be offloaded to Wi-Fi. Any IMS service may be offloaded to Wi-Fi or brought back from Wi-Fi to the cellular network according to operator policies (e.g., see FIG. 2).

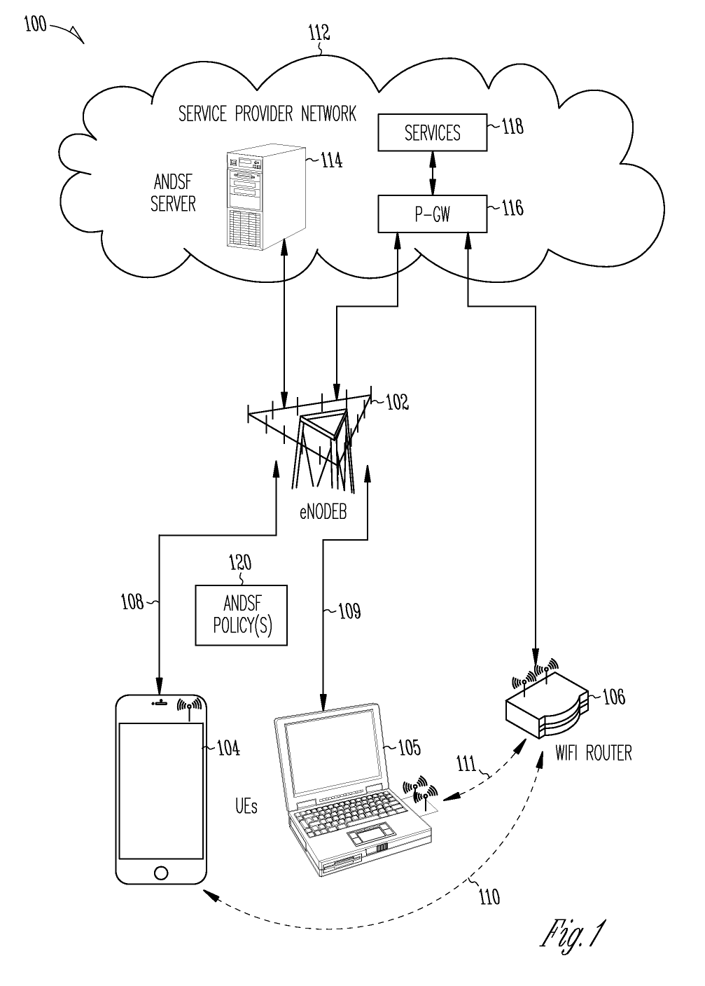

FIG. 1 illustrates a diagram of a mixed-mode communication network architecture 100. Within the network architecture 100, a carrier-based network (e.g., a LTE/LTE-A cell network operating according to a standard from a 3GPP standards family) is established by a carrier-based network system 102 (e.g., an evolved NodeB (eNodeB) establishing a cellular network, base station) communicating with multi-mode user equipment (UEs) 104, 105. A local area-based network system 106 (e.g., a Wi-Fi network operating according to a standard from an IEEE 802.11 standards family) may be established by local network equipment including a Wi-Fi router or access point 106. The carrier-based network includes network connections 108, 109 to the UE 104, 105, respectively; and the local-area based network includes network connections 110, 111 to the UE 104, 105 respectively. The UE 104, 105 are illustrated as conforming to different form factors, including a smartphone (UE 104) and a personal computer (UE 105) having an integrated or external wireless network communication device, although it will be understood that the same or other form factors may be used.

Wireless network communication connections 108-111 among the various UE 104, 105 may be facilitated using either the carrier-based network system 102 or the local area-based network system 106 in connection with the deployment of various offloading policies and preferences. The offloading policies and preferences may be communicated using one or more ANDSF policy(s) 120, communicated from an ANDSF server 114 via the carrier-based network system 102 (and network connections 108, 109).

The ANDSF server 114 may be located within a service provider network 112 of the carrier network. The service provider network 112 may include various components of an Evolved Packet Core (EPC) and other components of the 3GPP LTE/LTE-A network, including various services 118 and a P-GW (Packet Data Network (PDN) Gateway) 116. Data traffic offloaded to the local area-based network system 106 may be communicated back to the service provider network 112 through a connection with the P-GW 116. Thus, wireless network communications offloaded to another network architecture (wireless network connections 110, 111) may be used to access functionality of the service provider network 112.

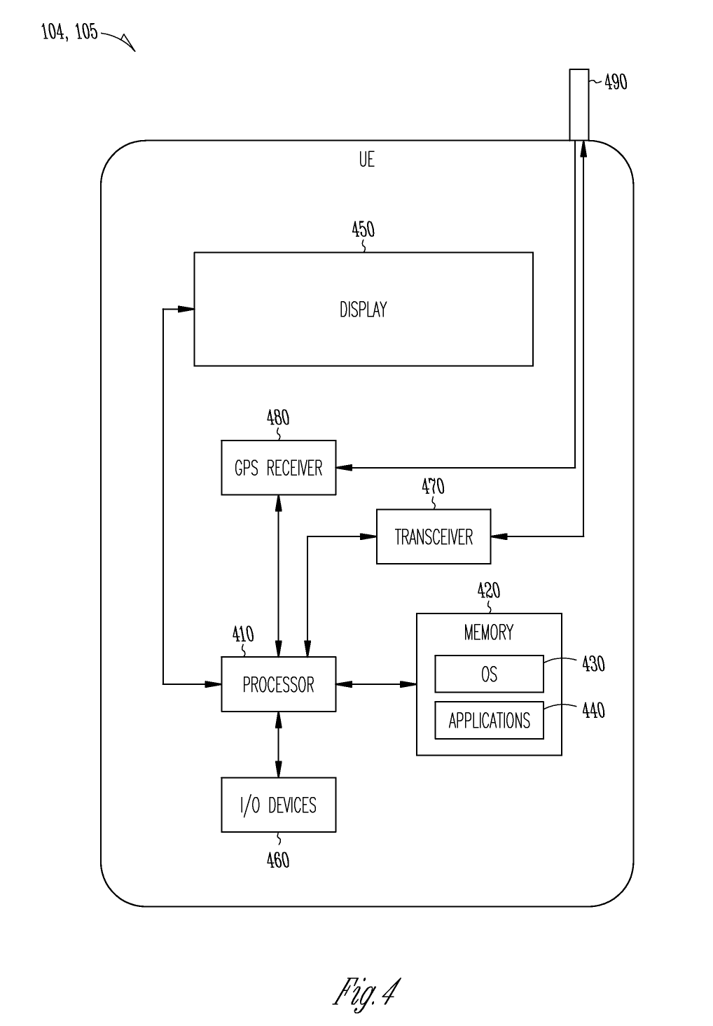

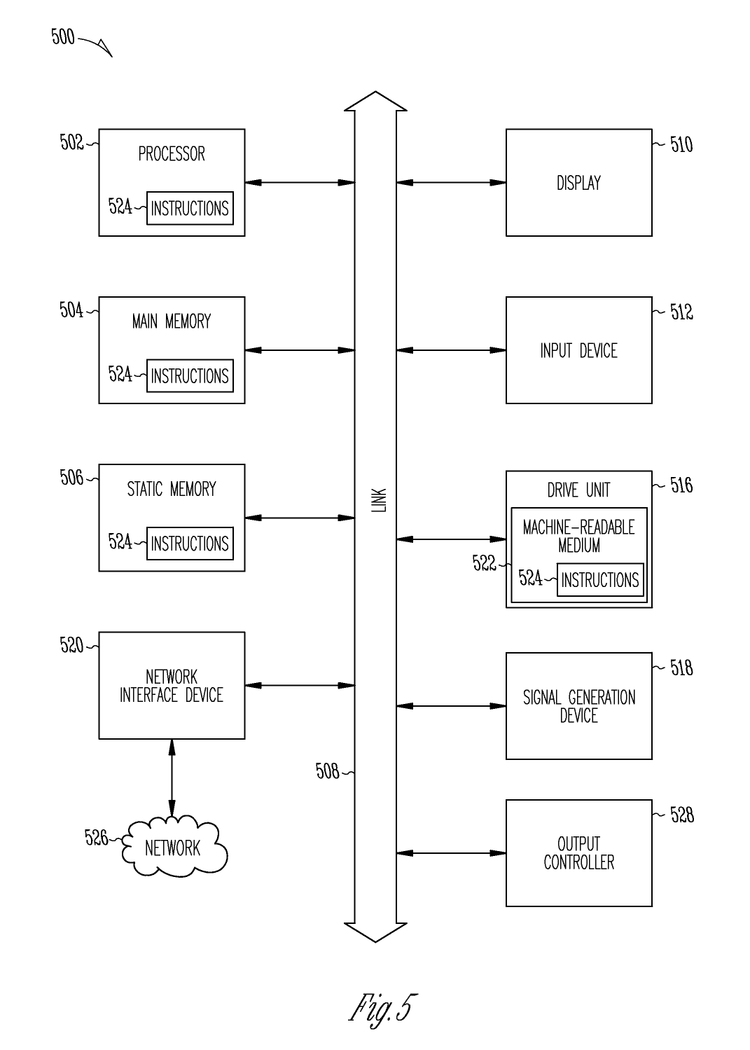

More detailed embodiments of the UE 104, 105 and ANDSF server 114 with eNodeB (e.g., base station) 102 are discussed subsequently with reference to FIGS. 4 and 5, respectively. These figures are for purposes of illustration only as the method for network access selection based on IMS service is not limited to operation on any particular device.

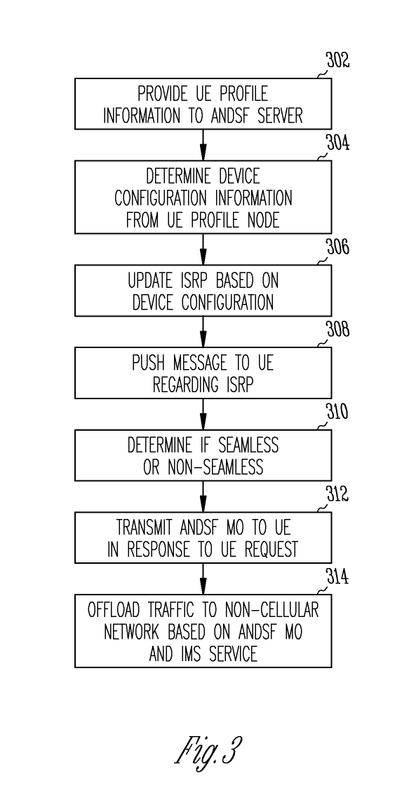

FIG. 2 illustrates a graphical representation of an embodiment of an ANDSF management object (MO) tree in accordance with the method for network access selection based on IMS service. The ANDSF MO tree may be the ISRP retrieved from the network by the UE. The retrieval may be initiated by the network pushing a message to a particular UE (see FIG. 3), the network broadcasting the ANDSF MO tree to all UE's within the network, or the UE retrieving the ANDSF MO tree based on its location with respect to the cellular network and/or any Wi-Fi AP's. The ANDSF MO may be generated in an extensible markup language (XML) format. The ANDSF MO tree may be a typical ANDSF MO and the UE 104, 105 may retrieve, in response to the pushed message, an update to the ANDSF MO that may add an additional node for the offloading function. The UE 104, 105 may then use the updated ANDSF MO for further operations.

The ANDSF MO tree includes the usage of IMS Communication Service Identifier (ICSI) and IMS Application Reference ID (IARI) identifier. The parameters added to the ANDSF MO tree may be the identification (ID) of the IMS services or the IMS applications that may be offloaded. As shown subsequently in FIG. 2, when the UE parses the policies of the ANDSF MO tree and determines that at least one of these identifiers is present, the UE can offload the traffic to the Wi-Fi network.

The selected IMS services or IMS applications that may be offloaded may be described in multiple ways. ICSI and IARI may be aggregated in Session Initiation Protocol (SIP) messages. Each IMS service may be identified uniquely by a single tag/identifier and, therefore, may not distinguish between IARIs and ICSIs. The tag value (IMSI or IARI) is referred to in FIG. 2 as “IMSRefld”. An example of an IMSRefld parameter for VoLTE ICSI may look like: +g.3gpp.icsi-ref=“urn %3Aurn-7%3gpp-service.ims.icsi.mmtel”. An example of a parameter for an image share IARI may look like: +g.3gpp.iari-ref=“urn %3Aurn-7%3gpp-application.ims.iari.gsma-is”. An example of a parameter for an RCS IP video call IARI may look like: +g.gsma.rcs.ipcall;video. These parameters are for purposes of illustration only and the present embodiments may use other ICSI and IARI parameters.

Referring to FIG. 2, the symbol “?” represents that there may be zero or one occurrence of the associated element. A zero occurrence means that the element is optional. The symbol “+” represents that there may be one or more occurrences of the associated element (i.e., the element is required). The ANDSF MO tree may be defined in accordance with 3GPP TS 24.312 and descriptions specification, although this is not a requirement as it may also be defined in accordance with the SOAP-XML protocol or other protocols. In accordance with these embodiments, the network to create and update the ANDSF MO tree for provisioning the UE 104, 105 may communicate over either the OMA-DM or the SOAP-XML protocol. AP 110 may be Wi-Fi Hotspot capable and may use HTTPS as the transport mechanism while connecting to a service provider's servers.

The ANDSF MO tree may include a plurality of nodes including a ForFlowBased node 201 that indicates that the following policies are for flow-based (e.g., seamless) operations as opposed to non-seamless. A container node 204 may be a container for a flow-based operation.

An IPFLOW node 206 may indicate an IP flow operation to be performed. A container node 208 may be a container for an IMS-Service-ID indication, an App-ID 214 indication, or a destination address indication 220. An IMS-Service-ID node 210 may include a container node 212 for an identifier (e.g., ICSI, IARI) of the type of IMS service to be offloaded. For example, the IMSRelfd 213 values are discussed previously.

A RoutingCriteria node 225 may have a container 240 for a routing parameter such as a current location of the UE 104, 105 or a validity period for the intersystem mobility policy rule. A ValidityArea node 226 may include a description (e.g., HESSID, SSID, BSSID, SID, NID) of the current location of the UE 104, 105 in relation to 3GPP, WiMAX, and/or WLAN systems or a geographic location of the UE 104, 105 based on latitude and longitude.

A TimeOfDay node 227 may have a container 241 for start and stop days and time 231 for applying the policies of the ANDSF MO. These may be an indication of the validity period 231 for the policies. The UE 104, 105 may consider a rule with the TimeOfDay present as valid only if the time of day in the current time zone, as indicated by the UE 104, 105, matches at least one time interval indicated in the TimeOfDay node.

A RoutingRule node 228 may have a container 242 for network access ID's, technology, or access priority 232. These parameters may specify the UE's network access technology (e.g., 3GPP, LTE) or priority that the UE 104, 105 has in accessing the network.

A RulePriority leaf 250 represents the priority given to one particular rule and may be represented as a numerical value. In case more than one valid intersystem mobility policy rule exists, the UE 104, 105 may treat the rule with the lowest RulePriority value as the rule having the highest priority among the valid rules.

FIG. 3 provides an example flowchart illustrating a method for network access selection based on IMS service. As illustrated, the flowchart includes a combination of actions performed at the ANDSF server and at the UE. However, it will be apparent that variations to the following overview method may include corresponding actions and techniques performed exclusively at the ANDSF server or the UE.

The method includes operations for communicating and obtaining the UE profile information, including providing the UE profile information from the UE to the ANDSF server (operation 302) and determining the device configuration information at the ANDSF server from the UE profile information from a UE_PROFILE node (operation 304). The UE profile information may be communicated in an ANDSF MO or in other data provided to the ANDSF server prior to deployment of the ISRP policy.

Next, the values of the particular ISRP policy are determined and the ISRP updated based on the device configuration information (operation 306). A message is pushed to the UE informing the UE that an ISRP is available (operation 308). In other embodiments, the ISRP may be pushed to the UE.

The ISRP is updated to factor the hardware and software configuration of the UE, but may provide multiple types of offload policy values to apply. Determining the appropriate set of policy values in the ISRP may include determining whether a seamless or non-seamless based traffic offloading is occurring (operation 310). The ANDSF MO is transmitted to the UE in response to a UE request (operation 312). The UE offloads the IMS traffic to the non-cellular network (e.g., Wi-Fi) based on the ANDSF MO and the IMS service (operation 314).

Although the preceding examples were provided with reference to a specific ANDSF server and policy usage in a 3GPP network, it will be understood that the use and deployment of identifying application information for network offloading may be provided in a variety of networks and using other types of deployment mechanisms. For example, non-ANDSF structures may be used to communicate all or portions of the policy information for specific software applications. Further, multi-mode UE may include any device capable of communication on the primary carrier network and a secondary offloaded network, including personal computers, notebooks and laptops, smartphones, tablets, mobile hotspots, media players, and the like.

FIG. 4 is a functional block diagram of a UE 104, 105 that may execute various operations for network access selection as discussed herein. The UE 104, 105 may include a processor 410. The processor 410 may be any of a variety of different types of commercially available processors suitable for UEs, for example, an XScale architecture microprocessor, a Microprocessor without Interlocked Pipeline Stages (MIPS) architecture processor, or another type of processor. A memory 420, such as a Random Access Memory (RAM), a Flash memory, or other type of memory, is typically accessible to the processor 410. The memory 420 may be adapted to store an operating system (OS) 430, as well as application programs 440. The OS 430 or application programs 440 may include instructions stored on a computer readable medium (e.g., memory 420) that may cause the processor 410 of the UE 400 to perform any one or more of the techniques discussed herein. The processor 410 may be coupled, either directly or via appropriate intermediary hardware, to a display 450 and to one or more input/output (I/O) devices 460, such as a keypad, a touch panel sensor, a microphone, etc. Similarly, in an example embodiment, the processor 410 may be coupled to a transceiver 470 that interfaces with an antenna 490. The transceiver 470 may be configured to both transmit and receive cellular network signals, wireless data signals, or other types of signals via the antenna 490, depending on the nature of the UE 400. Further, in some configurations, a GPS receiver 480 may also make use of the antenna 490 to receive GPS signals. The transceiver 470 may include a reception module for receiving the ANDSF MO that includes the ISRP for the UE.

The processor 410 in combination with the transceiver 470 and applications 440 together may be considered a routing module that may be responsible for the UE's portion of offloading the IMS service traffic from the cellular network to a non-cellular network.

FIG. 5 illustrates a block diagram of an embodiment of an ANDSF server with a base station or other machine 500 that may execute any one or more of the operations discussed herein. In an embodiment, the machine 500 may be UE 105. The machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a Personal Digital Assistant (PDA), a mobile telephone, a web appliance, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside (1) on a non-transitory machine-readable medium or (2) in a transmission signal. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., server, base station) 500 may include a hardware processor 502 (e.g., a processing unit, a graphics processing unit (GPU), a hardware processor core, or any combination thereof), a main memory 504, and a static memory 506, some or all of which may communicate with each other via a link 508 (e.g., a bus, link, interconnect, or the like). The machine 500 may further include a display device 510, and an input device 512 (e.g., a keyboard). In an example, the display device 510, and input device 512 may be a touch screen display. The machine 500 may additionally include a mass storage (e.g., drive unit) 516, a signal generation device 518 (e.g., a speaker), and a network interface device 520 (e.g., base station antenna). The machine 500 may include an output controller 528, such as a serial (e.g., universal serial bus (USB), parallel, or other wired or wireless (e.g., infrared (IR)) connection to communicate or control one or more peripheral devices (e.g., a printer, card reader, etc.).

The mass storage 516 may include a machine-readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the mass storage 516 may constitute machine-readable media.

While the machine-readable medium 522 is illustrated as a single medium, the terms “machine readable medium” or “computer readable medium” may include a single medium or multiple media (e.g., a centralized or distributed database, and/or associated caches and servers) that configured to store the one or more instructions 524.

The terms “machine-readable medium” or “computer readable medium” may include any tangible medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). The term “transmission medium” shall be taken to include any intangible medium that is capable of storing, encoding or carrying instructions for execution by the machine 500, and includes digital or analog communications signals or other intangible medium to facilitate communication of such software.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media.

### Examples

The following examples pertain to further embodiments.

Example 1 is user equipment, comprising: a receiver configured to receive, from an Access Network Discovery and Selection Function (ANDSF) server, an ANDSF management object (MO) that includes an inter-system routing policy (ISRP) based on an Internet Protocol (IP) Multimedia Subsystem (IMS) service identifier; and circuitry configured to perform offloading of selected IMS service traffic from a cellular network to a non-cellular network based on the ISRP and the IMS service identifier.

In Example 2, the subject matter of Example 1 can optionally include wherein the receiver is further configured to receive a pushed message from the cellular network that includes updates to the received ANDSF MO.

In Example 3, the subject matter of Examples 1-2 can optionally include wherein the receiver is further configured to retrieve the ANDSF MO from the cellular system in response to the pushed message.

In Example 4, the subject matter of Examples 1-3 can optionally include wherein the IMS service identifier comprises one of an IMS Communication Service Identifier (ICSI) or an IMS Application Reference ID (IARI) identifier.

In Example 5, the subject matter of Examples 1-4 can optionally include wherein the circuitry is further configured to perform offloading of the IMS service traffic based on the ICSI or IARI identifiers.

In Example 6, the subject matter of Examples 1-5 can optionally include wherein the circuitry is further configured to perform the offloading of the IMS service traffic based on the ICSI or IARI identifiers from the cellular network to a Wi-Fi network.

In Example 7, the subject matter of Examples 1-6 can optionally include wherein the receiver is further configured to receive the ANDSF MO that includes the ISRP as an extensible markup language (XML).

In Example 8, the subject matter of Examples 1-7 can optionally include wherein the receiver is further configured to receive the IMS service identifier as aggregated in a Session Initiation Protocol (SIP) message.

In Example 9, the subject matter of Examples 1-8 can optionally include wherein the receiver is further configured to receive the IMS service identifier.

Example 10 is a method for offloading Internet Protocol (IP) Multimedia Subsystem (IMS) service traffic from a cellular network to a non-cellular network, the method comprising: receiving a message from a cellular network comprising an ANDSF management object (MO) that includes an inter-system routing policy (ISRP) based on an Internet Protocol (IP) Multimedia Subsystem (IMS) service identifier; and offloading selected IMS traffic from the cellular network to a non-cellular network based on the IMS service identifier and the ISRP.

In Example 11, the subject matter of Example 10 can optionally include receiving a unique IMS identifier for each different IMS service.

In Example 12, the subject matter of Examples 10-11 can optionally include wherein the IMS identifier comprises an IMSRefld parameter.

In Example 13, the subject matter of Examples 10-12 can optionally include wherein the IMSRefld parameter comprises one of an image share IARI identifier, an RCS IP video identifier, or a VoLTE ICSI identifier.

In Example 14, the subject matter of Examples 10-13 can optionally include wherein the selected IMS traffic is one of video, VoIP, or high-bandwidth, lower QoS traffic.

In Example 15, the subject matter of Examples 10-14 can optionally include receiving a pushed message from the cellular network that the ANDSF MO is available; and retrieving the ANDSF MO from the cellular network in response to the pushed message.

In Example 16, the subject matter of Examples 10-15 can optionally include providing a user equipment profile to an ANDSF server.

In Example 17, the subject matter of Examples 10-16 can optionally include determining user equipment (UE) configuration information from a UE_PROFILE node; and updating the ISRP based on the UE configuration.

In Example 18, the subject matter of Examples 10-17 can optionally include communicating the UE configuration in the ANDSF MO.

In Example 19, the subject matter of Examples 10-18 can optionally include wherein receiving the message from the cellular network comprising the ANDSF MO comprises receiving the ANDSF MO in an extensible markup language (XML).

Example 20 is a non-transitory computer-readable storage medium that stores instructions for execution by one or more processors for network access selection based on an IMS service, the operations to select the network comprise: a user equipment (UE) receiving a message, from an Access Network Discovery and Selection Function (ANDSF) server, comprising an ANDSF management object (MO) that includes an inter-system routing policy (ISRP) based on an Internet Protocol (IP) Multimedia Subsystem (IMS) service identifier; and the UE offloading selected IMS traffic from the cellular network to a non-cellular network based on the IMS service identifier and the ISRP.

In Example 21, the subject matter of Example 20 can optionally include wherein the operations to select the network further comprise: a push message received from the ANDSF server that the ANDSF MO is available; and the UE retrieving the ANDSF MO from the ANDSF server.

In Example 22, the subject matter of Examples 20-21 can optionally include wherein the UE selects the network to offload the IMS service based on the ISRP and the IMS service identifier being one of an IMS Communication Service Identifier (ICSI) or an IMS Application Reference ID (IARI) identifier.

The Abstract is submitted with the understanding that it will not be used to limit or interpret the scope or meaning of the claims. The following claims are hereby incorporated into the detailed description, with each claim standing on its own as a separate embodiment.

What is claimed is:

1. A user equipment, comprising:
a receiver configured to receive, from an Access Network Discovery and Selection Function (ANDSF) server, an ANDSF management object (MO) that includes an inter-system routing policy (ISRP) based on an Internet Protocol (IP) Multimedia Subsystem (IMS) service identifier; and
circuitry configured to perform offloading of selected IMS service traffic from a cellular network to a non-cellular network based on the ISRP and the IMS service identifier.

2. The user equipment of claim 1, wherein the receiver is further configured to receive a pushed message from the cellular network that includes updates to the received ANDSF MO.

3. The user equipment of claim 2, wherein the receiver is further configured to retrieve the ANDSF MO from the cellular system in response to the pushed message.

4. The user equipment of claim 1, wherein the IMS service identifier comprises one of an IMS Communication Service Identifier (ICSI) or an IMS Application Reference ID (IARI) identifier.

5. The user equipment of claim 4, wherein the circuitry is further configured to perform offloading of the IMS service traffic based on the ICSI or IARI identifiers.

6. The user equipment of claim 5, wherein the circuitry is further configured to perform the offloading of the IMS service traffic based on the ICSI or IARI identifiers from the cellular network to a Wi-Fi network.

7. The user equipment of claim 1, wherein the receiver is further configured to receive the ANDSF MO that includes the ISRP as an extensible markup language (XML).

8. The user equipment of claim 1, wherein the receiver is further configured to receive the IMS service identifier as aggregated in a Session Initiation Protocol (SIP) message.

9. A method for offloading Internet Protocol (IP) Multimedia Subsystem (IMS) service traffic from a cellular network to a non-cellular network, the method comprising:
receiving a message from a cellular network comprising an ANDSF management object (MO) that includes an inter-system routing policy (ISRP) based on an Internet Protocol (IP) Multimedia Subsystem (IMS) service identifier; and
offloading selected IMS traffic from the cellular network to a non-cellular network based on the IMS service identifier and the ISRP.

10. The method of claim 9, further comprising receiving a unique IMS identifier for each different IMS service.

11. The method of claim 10, wherein the IMS identifier comprises an IMSRefld parameter.

12. The method of claim 11, wherein the IMSRefld parameter comprises one of an image share IARI identifier, an RCS IP video identifier, or a VoLTE ICSI identifier.

13. The method of claim 12, wherein the selected IMS traffic is one of video, VoIP, or high-bandwidth, lower QoS traffic.

14. The method of claim 9, further comprising:
receiving a pushed message from the cellular network that the ANDSF MO is available; and
retrieving the ANDSF MO from the cellular network in response to the pushed message.

15. The method of claim 9, further comprising providing a user equipment profile to an ANDSF server.

16. The method of claim 15, further comprising:
determining user equipment (UE) configuration information from a UE_PROFILE node; and
updating the ISRP based on the UE configuration.

17. The method of claim 16, further comprising communicating the UE configuration in the ANDSF MO.

18. The method of claim 9, wherein receiving the message from the cellular network comprising the ANDSF MO comprises receiving the ANDSF MO in an extensible markup language (XML).

19. A non-transitory computer-readable storage medium that stores instructions for execution by one or more processors for network access selection based on an IMS service, the operations to select the network comprise:
a user equipment (UE) receiving a message, from an Access Network Discovery and Selection Function (ANDSF) server, comprising an ANDSF management object (MO) that includes an inter-system routing policy (ISRP) based on an Internet Protocol (IP) Multimedia Subsystem (IMS) service identifier; and
the UE offloading selected IMS traffic from the cellular network to a non-cellular network based on the IMS service identifier and the ISRP.

20. The non-transitory computer-readable storage medium of claim 19 wherein the operations to select the network further comprise:
a push message received from the ANDSF server that the ANDSF MO is available; and
the UE retrieving the ANDSF MO from the ANDSF server.

21. The non-transitory computer-readable storage medium of claim 19 wherein the UE selects the network to offload the IMS service based on the ISRP and the IMS service identifier being one of an IMS Communication Service Identifier (ICSI) or an IMS Application Reference ID (IARI) identifier.
